(19) United States
(12) Patent Application Publication
(10) Pub. No.: US 2026/0348591 A1
(43) Pub. Date: Nov. 5, 2026

(54) SYSTEMS AND METHODS FOR BATTERY-ASSISTED COOKING IN A COOKING APPLIANCE

(71) Applicant: Haier US Appliance Solutions, Inc., Wilmington, DE (US)

(72) Inventor: Eric Scott Johnson, Louisville, KY (US)

(21) Appl. No.: 19/196,801

(22) Filed: May 2, 2025

(51) Int. Cl. F24C 7/08; H02J 1/14

(52) U.S. Cl. CPC F24C 7/087; F24C 7/082; H02J 1/14

(57) ABSTRACT

A method of operating a cooking appliance, the cooking appliance including one or more electric heaters, a main power connection to a main supply of electrical power at a first voltage, an auxiliary power connection to a battery supply of electrical power at a second voltage, and a power switching system. The method includes calculating a projected battery energy use or a cooking mode time needed to perform a selected cooking mode, determining an available battery energy of the battery supply or an available cook time for performing the selected cooking mode, and implementing a responsive action in response to determining that the projected battery energy use is greater than an available battery energy or that the cooking mode time is greater than an available cook time.

### FIELD OF THE INVENTION

The present subject matter relates generally to cooking appliances, and more particularly, to cooking appliances including an oven and/or cooktop and methods for facilitating battery-assisted cooking using the same.

### BACKGROUND OF THE INVENTION

Conventional residential and commercial cooking appliances generally include a cabinet that includes a cooking chamber (e.g., an oven chamber) for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber. In addition, cooking appliances commonly include a cooktop positioned on top of the oven chamber and having a plurality of gas burners or electric heating elements for heating pots, pans, etc. These cooking appliances are often called “oven range appliances,” “oven ranges,” or simply “ranges.”

Notably, conventional cooking appliances that include electric heating elements in the oven chamber and electric heating elements on the cooktop are powered by a main electricity supply. However, a user's kitchen may be wired for a first voltage (e.g., 120 VAC for a gas range), requiring rewiring by an electrician to use a conventional electric oven, cooktop, and/or range that operates at a second voltage (e.g., 240 VAC). Accordingly, purchasers of electric oven ranges may be disappointed when their product cannot be used when installed or when they need to hire an electrician to rewire prior to operation. In addition, conventional cooking appliances are operated entirely from mains electricity, thus providing no ability to reduce peak loads on the electrical grid, shift energy use to off-peak times, etc.

Accordingly, an electric cooking appliance that may operate using an energy source other than mains electricity would be desirable. More specifically, a cooking appliance that is versatile and operates to reduce peak load on the electrical grid, shift energy use to off-peak times, and operate more efficiently would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a cooking appliance is provided including a cabinet defining a cooking chamber, one or more electric heaters in thermal communication with the cooking chamber, a main power connection to a main supply of electrical power at a first voltage, an auxiliary power connection to a battery supply of electrical power at a second voltage, a power switching system configured to selectively couple at least one of the main power connection or the auxiliary power connection to the one or more electric heaters, and a controller in operative communication with the power switching system. The controller is configured to receive a user input to perform a selected cooking mode, calculate a projected battery energy use or a cooking mode time needed to perform the selected cooking mode, determine an available battery energy of the battery supply or an available cook time for performing the selected cooking mode, determine that the projected battery energy use is greater than the available battery energy or that the cooking mode time is greater than the available cook time, and implement a responsive action in response to determining that the projected battery energy use is greater than the available battery energy or that the cooking mode time is greater than the available cook time.

In another exemplary embodiment, a method of operating a cooking appliance is provided. The cooking appliance includes one or more electric heaters, a main power connection to a main supply of electrical power at a first voltage, an auxiliary power connection to a battery supply of electrical power at a second voltage, and a power switching system configured to selectively couple at least one of the main power connection or the auxiliary power connection to the one or more electric heaters. The method includes receiving a user input to perform a selected cooking mode, calculating a projected battery energy use or a cooking mode time needed to perform the selected cooking mode, determining an available battery energy of the battery supply or an available cook time for performing the selected cooking mode, determining that the projected battery energy use is greater than the available battery energy or that the cooking mode time is greater than the available cook time, and implementing a responsive action in response to determining that the projected battery energy use is greater than the available battery energy or that the cooking mode time is greater than the available cook time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking appliance according to an example embodiment of the present subject matter.

FIG. 2 provides a front perspective view of the example cooking appliance of FIG. 1 with a door in the open position according to an example embodiment of the present subject matter.

FIG. 3 provides a side, schematic view of the example cooking appliance of FIG. 1 according to an example embodiment of the present subject matter.

FIG. 4 provides a side, schematic view of a heating system of the example cooking appliance of FIG. 1 according to an example embodiment of the present subject matter.

FIG. 5 provides a side, schematic view of a heating system of the example cooking appliance of FIG. 1 according to another example embodiment of the present subject matter.

FIG. 6 provides an electrical schematic view of a heating system and power switching system of the example cooking appliance of FIG. 1 according to an example embodiment of the present subject matter.

FIG. 7 provides a method of operating a heating system of the example cooking appliance of FIG. 1 according to an example embodiment of the present subject matter.

FIG. 8 provides a method of operating a heating system of the example cooking appliance of FIG. 1 according to an example embodiment of the present subject matter.

FIG. 9 provides a method of operating a heating system of the example cooking appliance of FIG. 1 according to an example embodiment of the present subject matter.

FIG. 10 provides a method of operating a heating system of the example cooking appliance of FIG. 1 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to a control system that powers an oven, a cooktop, and/or a cooking range using a combination of mains electric supply and battery power. The cooking range, the electric cooktop, and/or the oven heater may include a power connection to a main supply with a first voltage (e.g., 120 VAC), a battery with a second voltage (e.g., 230 VDC), and a controller that receives and distributes power to heaters. One or more switches may be utilized that gate power to oven and/or cooktop heaters from the main supply and/or battery. Further, one or more oven heaters may include two or more stages, one powered from main supply and another powered from battery.

According to an example embodiment, oven heaters may be powered from a main supply at a first voltage (e.g., 120 VAC) and/or a battery at a second voltage (e.g., 230 VDC). One or more switches (e.g., relays, contactors, or transistors) may be used to gate power from the two sources to one or more oven heaters on their high-voltage side, and an additional one or more switches may be used to gate power to the two sources return on the heater's low-voltage side. These switches may be wired for each heater such that when the switch on the high-voltage side draws power from a first source, the switch on the low-voltage side may be adjusted to return power to the first source (and similarly for the second source).

Methods are also described that project the amount of battery energy used by a selected cooking mode in a cooking appliance such as an oven, cooktop, or cooking range that is powered by a main supply and/or a battery. The battery may be part of the appliance or a home battery supply connected to the appliance. The appliance includes a controller for receiving user input and distributing power to heaters, and may also include a communication means to communicate with a home battery supply (e.g., to share battery state of charge, etc.). When the user requests a cooking mode, the appliance determines available battery energy. The available battery energy is compared against the energy projected to be used during the cook mode and options and/or guidance are provided to manage the projected battery energy usage. Based on the available battery energy, the amount and/or proportion of power drawn from the main supply and the battery are adjusted (e.g., by adjusting heater power sources, heater duty cycles, and/or heater power settings). If the available battery energy is insufficient to complete the cooking mode, one or more adjustments are made (or provided as options to the user) to reduce the amount of projected battery energy use to an amount less than the available battery energy to allow the cooking mode to complete. The determination of available battery energy may be based on battery state of charge, battery voltage, historical battery voltage, historical battery current draw, battery age, charge/discharge history, time required to charge, and/or battery temperature.

The method of determining if the projected battery energy use is greater than the available battery energy may include determining a cook mode time (e.g. entered by a user or estimated by the product) and projected battery power use. Projected battery energy use may be based on cook mode time and projected battery power use. Alternatively, the product may calculate an available cook time (e.g., the projected amount of time the cook mode can operate before exhausting the available battery energy) based on projected battery power use and available battery energy, and if the cook mode time is greater than the available cook time, this indicates that the projected battery energy use is greater than the available battery energy. A margin factor may be used to adjust the cook mode time, available cook time, projected battery power/energy use, and/or available battery energy to provide a contingency or safety factor. Communications may be provided to the user regarding the available battery energy using available cook time and/or projected energy use of the selected mode.

The product may estimate a cook mode time based on programmed values or transfer functions (e.g., energy required to preheat to a given temperature, paired with power use of cook mode), cook mode settings, temperature of cookware and/or food, identification of cookware and/or food (e.g., from a camera image), or historical usage. Projected battery power use may be based on cook mode setting (e.g., heater power sources, heater duty cycles, heater power settings), programmed values or transfer functions, historical usage, or call-for-heat timing estimates.

Heater power settings may include settings for PWM or TRIAC controllers, infinite switches, and/or induction cooktop frequency controllers. Call-for-heat timing estimates may be based on programmed values or transfer functions, temperature of cookware and/or food, identification of cookware and/or food, or historical usage. Projected battery energy use or available cook time may optionally be based on the amount of battery charging projected to take place during the cook mode (e.g., the battery may be charged during periods when the product's heaters are not powered by the battery, such as when an oven is not calling for heat).

For multi-phase cooking modes (e.g., those that include a preheat phase and a cooking phase), cook phase time, available cook phase time, and/or projected battery power/energy use are determined for each phase. Subsequent available cook phase times are calculated from projected battery energy remaining after initial phases, i.e., calculated using initial cooking phase time(s) and projected battery power/energy use during initial cook phases. Cook mode and/or phase times may include periods when food is not being cooked, but the cooking appliance is generating heat (e.g., during a preheat phase).

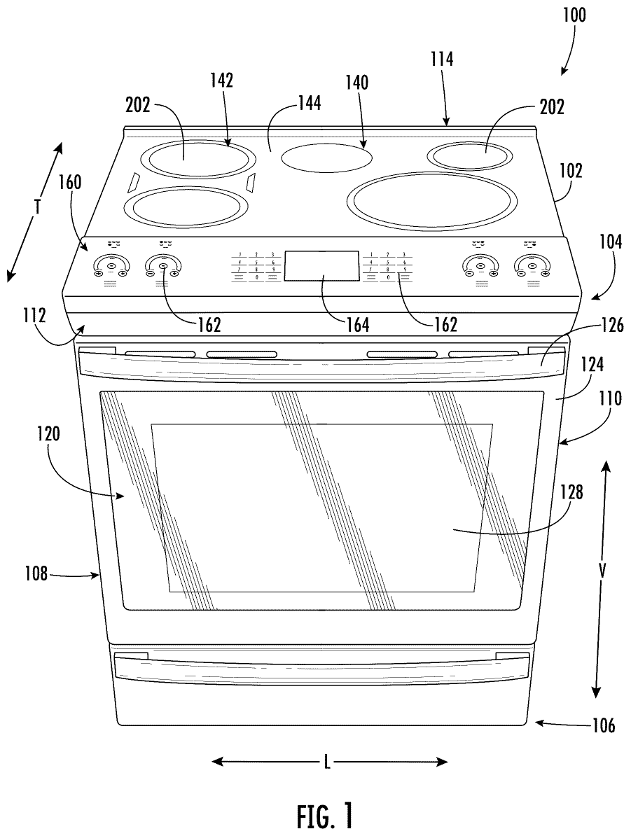

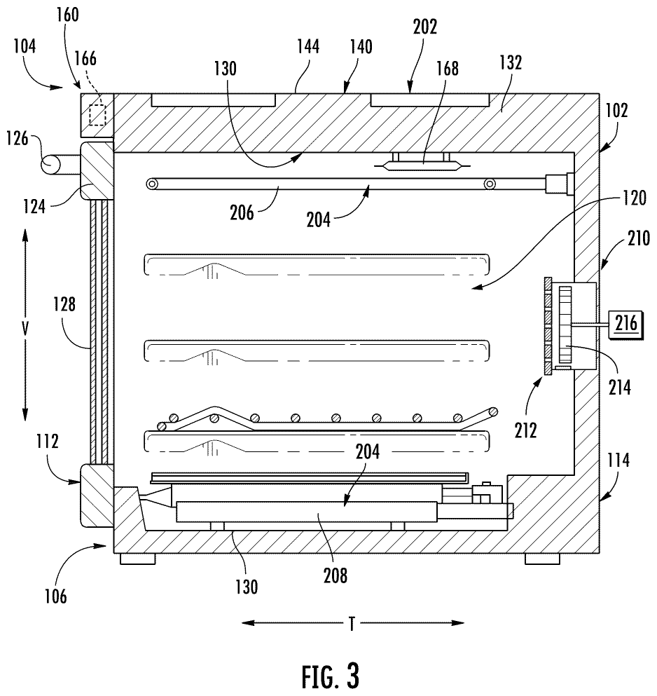

FIG. 1 provides a front, perspective view of a cooking appliance 100 as may be employed with the present subject matter. Cooking appliance 100 generally defines a vertical direction V, a lateral direction L, and a transverse direction T, each of which is mutually perpendicular, such that an orthogonal coordinate system is generally defined. As illustrated, cooking appliance 100 includes an insulated cabinet 102. Cabinet 102 of cooking appliance 100 extends between a top 104 and a bottom 106 along the vertical direction V, between a first side 108 (left side when viewed from front) and a second side 110 (right side when viewed from front) along the lateral direction L, and between a front 112 and a rear 114 (FIG. 3) along the transverse direction T.

Within cabinet 102 is a single cooking chamber 120 which is configured for the receipt of one or more food items to be cooked. However, it should be appreciated that cooking appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to any suitable cooking appliance.

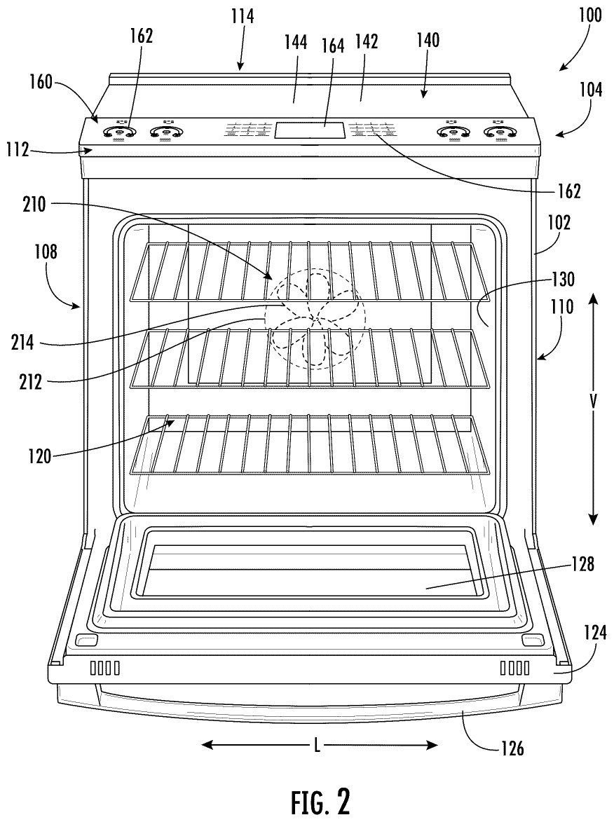

Referring now also to FIGS. 2 and 3, cooking appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

Cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, cooking appliance 100 includes an insulating gap defined between the chamber walls 130 and cabinet 102. According to an exemplary embodiment, the insulation gap is at least partially filled with an insulating material 132, such as insulating foam or fiberglass, for insulating cooking chamber 120.

Cooking appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. For example, according to the illustrated embodiment, cooktop includes a ceramic glass panel 144 having a plurality of cooking zones.

Although aspects of the present subject matter are described herein in the context of a single cooking appliance, it should be appreciated that cooking appliance 100 is provided by way of example only. Other oven or range appliances having different configurations, different appearances, and/or different features may also be utilized with the present subject matter, e.g., double ovens, standalone cooktops, etc.

As illustrated, cooking appliance 100 may generally include a user interface panel 160 that is located within convenient reach of a user of the cooking appliance 100. For example, according to the illustrated embodiment, user interface panel 160 is mounted at a front 112 and top 104 corner of cabinet 102, e.g., directly above door 124. Although user interface panel 160 is illustrated as being mounted at a top, front of cabinet 102, it should be appreciated that aspects of the present subject matter may be applicable to other mounting locations of control panels, e.g., such as front mount control panels, rear mount panels, etc. In addition, it should be appreciated that the present subject matter is not limited oven applications but could instead be applied to any other suitable appliance.

For this example embodiment, user interface panel 160 includes control inputs 162 that are each associated with one or more heating elements of cooking appliance 100. In this manner, control inputs 162 allow the user to activate each heating element and determine the amount of heat input provided by each heating element to a cooking food items within cooking chamber 120 or on cooktop 140. Although control inputs 162 are illustrated as touch-sensitive or contact inputs, it should be understood that control inputs 162 and the configuration of cooking appliance 100 shown in FIG. 1 is provided by way of example only. More specifically, user interface panel 160 may include various input components, such as one or more of a variety control knobs, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element is activated and/or the rate at which the heating element is set.

User interface panel 160 may be in direct operative communication with a controller 166 of cooking appliance 100, such that user inputs via user interface panel 160 may be directly used to regulate operation of various components of cooking appliance 100. User interface panel 160 of cooking appliance 100 may be in communication with controller 166 via, for example, one or more signal lines or shared communication busses, and signals generated in controller 166 operate cooking appliance 100 in response to user input via user input devices 162. Input/Output (“I/O”) signals may be routed between controller 166 and various operational components of cooking appliance 100 such that operation of cooking appliance 100 can be regulated by controller 166.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of cooking appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

In addition, controller 166 may also be in communication with one or more sensors, such as temperature sensor 168 (FIG. 3), which may be used to measure temperature inside cooking chamber 120 and provide such measurements to the controller 166. A temperature sensor may also be used to measure the temperatures of the glass cooktop, cookware on the glass cooktop, etc. As used herein, “temperature sensor” or the equivalent is intended to refer to any suitable type of temperature measuring system or device positioned at any suitable location for measuring the desired temperature. Thus, for example, temperature sensor 168 may each be any suitable type of temperature sensor, such as a thermistor, a thermocouple, a resistance temperature detector, a semiconductor-based integrated circuit temperature sensor, etc. In addition, temperature sensor 168 may be positioned at any suitable location and may output a signal, such as a voltage, to a controller that is proportional to and/or indicative of the temperature being measured. Although exemplary positioning of temperature sensors is described herein, it should be appreciated that cooking appliance 100 may include any other suitable number, type, and position of temperature and/or other sensors according to alternative embodiments.

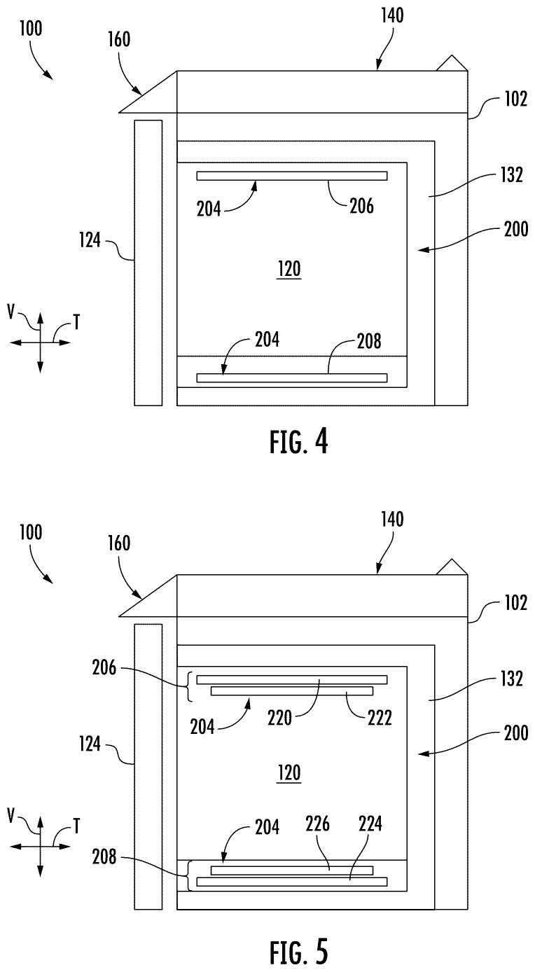

Referring now generally to FIGS. 1 through 5, a heating system 200 of cooking appliance will be described according to an example embodiment of the present subject matter. Cooking appliance 100 may further include one or more heating elements or cooktop heaters (identified generally by reference numeral 202) for selectively heating cooking utensils positioned on glass panel 144. For example, referring to FIG. 1, cooktop heaters 202 may be electric heating elements or induction heating elements. Specifically, a plurality of cooktop heaters 202 are mounted within or on top of top panel 142 underneath a glass panel 144 that supports cooking utensils over the cooktop heaters 202 while cooktop heaters 202 provide thermal energy to cooking utensils positioned thereon, e.g., to heat food and/or cooking liquids (e.g., oil, water, etc.).

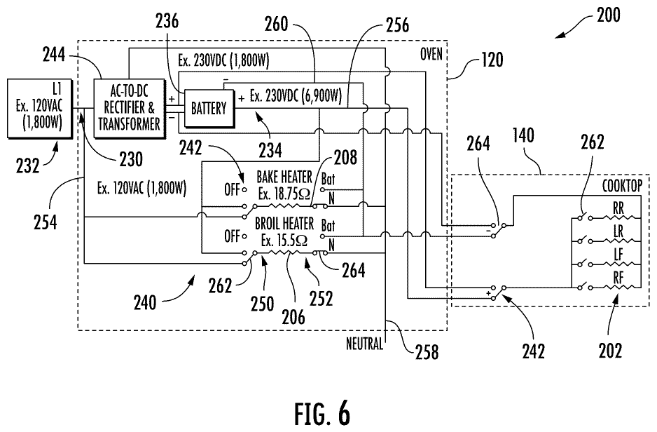

Cooktop heaters 202 can be configured in various sizes so as to provide e.g., for the receipt of cooking utensils (i.e., pots, pans, etc.) of various sizes and configurations and to provide different heat inputs for such cooking utensils. For example, as shown in FIG. 1, cooktop 140 includes five cooktop heaters 202 of different sizes, each of which may be independently controlled to facilitate operation of cooktop 140. By contrast, as shown in the schematic representation of FIG. 6, cooktop 140 may include four cooktop heaters 202, e.g., a rear right heater (RR), a left rear heater (LR), a left front heater (LF), and a right front heater (RF). According to alternative embodiments, cooking appliance 100 may have other cooktop configurations or burner elements.

In addition, cooking appliance 100 may include one or more chamber heaters 204 that may be positioned within or may otherwise be in thermal communication with cooking chamber 120 for regulating the temperature within cooking chamber 120. Specifically, an upper chamber heater, also referred to as a broil heating element 206, may be positioned in cabinet 102, e.g., at a top portion of cooking chamber 120, and a lower chamber heater, also referred to as a bake heating element 208, may be positioned at a bottom portion of cooking chamber 120. Broil heating element 206 and bake heating element 208 may be used independently or simultaneously to heat cooking chamber 120, perform a baking or broil operation, perform a cleaning mode, etc. The size and heat output of heating elements 206, 208 can be selected based on the, e.g., the size of cooking appliance 100 or the desired heat output. According to example embodiments, broil heating element 206 and bake heating element 208 are electric heating elements. Cooking appliance 100 may include any other suitable number, type, and configuration of heating elements 202 within cabinet 102 and/or on cooktop 140.

In some embodiments, cooking appliance 100 includes a convection heating assembly 210 that operates in conjunction with chamber heaters 204 (e.g., broil heating element 206 and bake heating element 208) to facilitate convection cooking within cooking chamber 120. In this regard, convection heating assembly 210 may operate to circulate a flow of heated air within cooking chamber 120 to facilitate more even heating and shorter cooking mode times. Although an example convection heating assembly 210 is described below, it should be appreciated that variations and modifications may be made while remaining within the scope of the present subject matter.

As best shown in FIG. 3, convection heating assembly 210 includes a convection fan enclosure 212 positioned proximate a rear of cooking chamber 120. In this regard, convection fan enclosure 212 is defined at least partially by a front wall and a rear wall spaced apart along the transverse direction T. The front wall may define one or more apertures that permit the flow of heated air to pass into and out of convection fan enclosure 212. According to alternative example embodiments, convection fan enclosure 212 may include alternative airflow paths, ducts, or other flow regulating devices for directing the flow of heated air within convection fan enclosure 212 and throughout cooking chamber 120.

As illustrated, convection heating assembly 210 further includes a convection fan 214 mounted in cabinet 102 (e.g., within convection fan enclosure 212) for circulating the flow of heated air in cooking chamber 120. Specifically, convection fan 214 is illustrated as a centrifugal fan, though other suitable fan types and configurations are possible and within the scope of the present subject matter. A drive motor 216 may be mounted to cabinet 102 and may be mechanically coupled to convection fan 214 for selectively rotating convection fan 214. Controller 166 may be in operative communication with drive motor 216 for selectively rotating convection fan 214 at desired times within a cooking mode.

Referring now specifically to FIG. 5, each chamber heater 204 may include one or more heating stages that may be powered collectively or independently depending on the heating needs of cooking chamber 120 or the power available to cooking appliance 100. For example, as illustrated, broil heating element 206 may include a first heating stage 220 and a second heating stage 222. Similarly, bake heating element 208 may include a first heating stage 224 and a second heating stage 226. In general, the term “heating stages” may refer to subsets of chamber heaters 204 that are positioned adjacent to each other on the same face of the oven chamber or are embodied as a single heating element but which may be independently operated. According to example embodiments, these heating stages may each include different resistances, thereby facilitating versatility in the heating power applied through chamber heaters 204. Other variations and modifications to chamber heaters 204 and their respective heating stages are possible and within the scope of the present subject matter.

Referring now also to FIG. 6, an electrical schematic view of heating system 200 will be described according to example embodiments of the present subject matter. As shown, heating system 200 may include a main power connection 230 to a main supply 232 of electrical power and an auxiliary power connection 234 to a battery supply 236. In this regard, cooking appliance 100 may be an electric oven that facilitates battery-assisted cooking. According to an example embodiment, main supply 232 may provide power at a first voltage (e.g., 120 VAC) and battery supply 236 may provide power at a second voltage (e.g., 230 VDC). It should be appreciated that these supply voltages may vary, and additional or alternative power sources may be incorporated into heating system 200 while remaining within the scope of the present subject matter.

According to example embodiments, main supply 232 may be mains electricity, e.g., provided by a utility provider to a conventional 120 VAC outlet within a user's residence. Battery supply 236 may be a battery supply or battery bank stored within cabinet 102 of cooking appliance 100 or may be a home battery supply electrically coupled or wired to cooking appliance 100. According to example embodiments, controller 166 may have a communication link with battery supply 236 (e.g., a remote connection with the home battery supply) for receiving operating parameters of battery supply 236, e.g., such as operating voltage, a maximum battery supply power draw, or other useful information.

As noted above, conventional cooking appliances that include electric heating elements in the oven chamber and electric heating elements on the cooktop are powered by a main electricity supply. However, a user's kitchen may be wired for a first voltage (e.g., 120 VAC for a gas range), requiring rewiring by an electrician to use a conventional electric oven, cooktop, and/or range that operates at a second voltage (e.g., 240 VAC). Accordingly, purchasers of electric cooking appliances may be disappointed when their product cannot be used when installed or may need to hire an electrician to rewire prior to operation. Heating system 200 may solve this problem by facilitating operation at a higher voltage, e.g., via use of power electronics and a higher voltage battery supply 236. Aspects of the present subject matter are directed to heating system 200 and power control systems and methods for facilitating such battery-assisted operation of cooking appliance 100.

In this regard, referring still to FIG. 6, heating system 200 may include a power switching system 240 configured to selectively couple main supply 232 and battery supply 236 to various heating elements of heating system 200. In this regard, power switching system 240 may include one or more switches 242, power electronics, power busses, and other electricity regulating devices for controlling the flow of power throughout heating system 200. In this regard, switches 242 may include single pole double throw relays, double pole double throw relays, contactors, transistors, or any other suitable devices for toggling, switching, or regulating the flow of electricity.

Power switching system 240 may also include a power electronics system 244 for converting alternating current (AC) power to direct current (DC) power or for converting DC power to AC power. For example, power electronics system 244 may include one or more inverters, rectifiers, voltage transformers, or other power electronics devices for converting power from AC to DC power (and vice versa), for adjusting voltage output, or for otherwise regulating or manipulating the flow of electricity as needed based on the call for heat from heating system 200.

According to the illustrated example embodiments, each heating element in heating system 200 (e.g., cooktop heaters 202 and chamber heaters 204) may include a high-voltage side 250 and a low-voltage side 252. Power switching system 240 may operate to selectively couple high-voltage sides 250 with a line connection 254 of main supply 232 or a positive terminal 256 of battery supply 236, e.g., based on a command from controller 166. Similarly, power switching system 240 may operate to selectively couple low-voltage sides 252 with a neutral line 258 of main supply 232 or a negative terminal 260 of battery supply 236, e.g., based on a command from controller 166.

As explained above, power switching system 240 includes one or more switches 242 to route power within power switching system 140 and heating system 200. For example, as illustrated in FIG. 6, switches 242 may include a high-side switch 262 for selectively coupling high-voltage side 250 of a particular heating element to line connection 254 of main supply 232 or positive terminal 256 of battery supply 236. In addition, switches 242 may include a low-side switch 264 for selectively coupling low-voltage side 252 to neutral line 258 of main supply 232 or negative terminal 260 of battery supply 236. As illustrated, high-side switches 262 and low-side switches 264 may be used to selectively route power to one or more cooktop heaters 202 and/or one or more chamber heaters 204.

According to another example embodiment, instead of having a high-side switch 262 and a low side switch 264 for each heating element, a first stage 220 of a first chamber heater, e.g., such as broil heating element 206, may be hard-wired to negative terminal 260 of battery supply 236, and a second stage 222 of the first chamber heater may be hard-wired to neutral line 258 of main supply 232. According to such an embodiment, power switching system 240 may include a battery supply switch for selectively coupling the first stage 220 of the first heating element (e.g., broil heating element 206) to battery supply 236 and a line supply switch for selectively coupling the second stage 222 of the first heating element to main supply 232.

As will be explained in more detail below, controller 166 may be in operative communication with power switching system 240 to regulate power flow based at least in part on the call for heat received from the temperature sensor and controller for regulating the operation of each respective heating element (e.g., cooktop heaters 202 and/or chamber heaters 204). In this regard, controller 166 may be configured to receive a call for heat associated with operation of the heating element (e.g., based on a user input via control inputs 162, a change in system state, etc.), determine a power schedule utilizing at least one of main supply 232 or battery supply 236, and operate power switching system 240 to deliver power to the heating element from at least one of 232 main supply or battery supply 236 in accordance with the power schedule. According to an example embodiment, the power schedule minimizes power drawn from battery supply 236. In addition, in cases where a chamber heater 204 includes two stages, the power schedule may include powering first stage 220/224 using only battery supply 236 and powering second stage 222/226 using only main supply 232.

As explained above, a user's kitchen may be wired for a first voltage (e.g., 120 VAC for a gas range), requiring rewiring by an electrician to use a conventional electric oven, cooktop, and/or range that operates at a second voltage (e.g., 240 VAC). A product that includes a battery that can be charged and/or powered by main supply would remove the need for rewiring, reduce peak load on the electrical grid, and shift energy use to off-peak times. Accordingly, aspects of the present subject matter are directed to a battery-assisted cooking appliance along with methods to guide the user in selecting and adjusting modes for this product.

For example, a situation could arise in which the remaining energy of a battery is insufficient to complete a cooking mode selected by a user. Aspects of the present subject matter describe a method to reduce the amount of battery energy used by the cook mode to enable this selected cooking mode to complete. These methods may also apply to an oven, cooktop, and/or range powered by both main supply and a home battery system.

According to an example embodiment, a method may be provided to project the amount of battery energy used by a selected cooking mode of a product that can be powered by a main supply and/or a battery. If the available battery energy is insufficient to complete the cook mode, one or more adjustments are made (or provided as options to the user) prior to, upon, or after starting cook mode to reduce the amount of battery energy projected to be used by the cook mode to allow the cook mode to complete. Examples of such methods will be described herein.

For example, methods of projecting energy usage and adjusting the performance of a selected cook mode to operate within an available battery charge are provided. In addition, or alternatively, methods may include refinement of the available battery energy (e.g., using battery state-of-charge, battery age, charge/discharge history, time required to charge, and/or battery temperature). According to an example embodiment, methods may also include adjustment of the cook mode time, available cook time, projected battery power/energy use, and/or available battery energy using a margin factor. Communications may be provided to the user regarding the available cook time and/or projected battery energy use of the selected cook mode.

As explained above, cooking appliance 100 may be used to implement the presently disclosed methods. According to alternative embodiments, any other suitable cooking appliance may implement such methods, e.g., such as a cooking range that includes a power connection to a main supply, a controller that receives user input and distributes power to heaters, an electric cooktop and/or oven heaters, and either a battery or a power connection to home battery supply with a second voltage. Suitable appliances may also include an induction cooktop system that may be powered either from a main supply and/or battery. Appliances may also include a means of communicating with a home battery supply (e.g., to share battery state of charge, etc.).

For example, a product that may be powered by a main supply and/or a battery includes a means to permit an oven and/or cooktop cook mode requested by a user to be completed within the available battery energy. The controller may project battery energy use based on a variety of factors, such as projected battery power use and cook time of the cook mode, as described in more detail below. Available cook time may be calculated based on projected battery power use and available battery energy. Available battery energy may be compared against projected battery energy use, or available cook time may be compared against cook mode time. If projected battery energy use is greater than available battery energy, or if cook mode time is greater than available cook time, options and/or guidance may be provided to manage heater power and/or battery use to reduce the amount of projected battery energy use to an amount less than the available battery energy to allow the cooking mode to complete. Reducing battery energy use may be achieved by adjusting heater power sources, heater duty cycles, and/or heater power settings. The controller may adjust the battery usage of the selected cook mode to lower the projected battery energy use below the available battery energy (or raise the available cook time above the cook mode time), present the user with alternative cook modes that use less battery energy, or prohibit the selection of the cooking mode.

Any suitable power regulating devices may be used to adjust the amount and/or proportion of power drawn from the main supply and the battery. For example, for the oven, heater timings (e.g., a duty cycle control scheme using relays, contactors, transistors, etc.), a PWM controller, and/or a TRIAC may be used to regulate the distribution of power. For the cooktop, heater timings (e.g., a duty cycle control scheme using relays, contactors, transistors, etc.), an induction cooktop frequency controller, a PWM controller, and/or a TRIAC may be used to regulate the distribution of power.

Cook mode time may be entered by a user, pre-programmed, or estimated using programmed values or transfer functions (e.g., energy required to preheat to a given temperature, paired with power use of cook mode), cook mode settings (e.g., type and/or set temperature), temperature of cookware and/or food, use history (e.g., previous cook mode times), and/or identification of food/cookware load (e.g., from user input, camera image, etc.). Cook mode times for multi-phase cook modes (e.g., those that include both a preheat phase and a cooking phase) may be determined using different methods for each phase (e.g., estimated for a first phase and entered by a user for a second phase).

Available battery energy may be based on one or more of battery state-of-charge, battery voltage, historical battery voltage, and historical battery current draw. Factors that influence the battery's discharge behavior (e.g., linearity) may also optionally be used to improve the accuracy of available battery energy. Such factors may include, but are not limited to, battery age, battery charge/discharge history (e.g., voltage/current versus time), time required to charge, and/or battery temperature.

The projected battery energy use of a cook mode may be calculated as a product of cook mode time and projected battery power use during the cook mode (e.g., average projected battery power multiplied by cook mode time, or the sum of projected battery power use over discrete time periods multiplied by those time periods). The projected battery power use of a cook mode may be calculated from cook mode setting (e.g., heater power sources, heater duty cycles controlled by relays/contactors/transistors/etc., heater power settings), programmed values or transfer functions, historical usage, or call-for-heat timing estimates (e.g., heater control methods which include time periods where heaters are powered and periods where heaters are not powered). Heater power settings may include settings for PWM or TRIAC controllers, infinite switches, and/or induction cooktop frequency controllers (e.g., where frequency may be a function of heater inductance, phase angle when cookware is present, etc.). The call-for-heat timing may be estimated using predetermined values or transfer functions (e.g., based on set temperature), cook mode settings (e.g., type and/or set temperature), temperature of cookware and/or food, use history (e.g., previously-measured call-for-heat timing), and/or identification of food/cookware load (e.g., from user input, camera image, etc.). Projected battery energy use or available cook time may also be optionally based on the amount of battery charging projected to take place during the cook mode (e.g., the battery may be charged during periods when the product's heaters are not powered by the battery, such as when an oven is not calling for heat).

A margin factor may be used to adjust the cook mode time, available cook time, projected battery power/energy use, and/or available battery energy to account for uncertainty and provide flexibility if user chooses to cook longer (e.g., make a conservative assumption that the product will need to operate for 25% more time than expected, or that available cook time is 20% less than it actually is, or that available battery energy is 20% less than it actually is).

This method may be extended to multi-phase cooking modes (e.g., those that include a preheat phase and a cooking phase) by determining a cook phase time, available cook phase time, and/or projected battery power/energy use for each cook mode phase. Each projected battery energy use during a cook phase may be compared to an available battery energy projected to be available at the beginning of that phase. Alternatively, each cook phase time may be compared to an available cook phase time projected to be available at the beginning of that phase. In other words, subsequent available cook phase times may be calculated from projected battery energy remaining after initial phases, i.e. calculated using initial cook phase time(s) and projected battery power energy use during initial cook phases. If any projected battery energy use during a cook phase is greater than the available battery energy at the start of that phase, or if any cook phase time is greater than the available cook time for that phase, options and/or guidance may be provided to manage heater power and/or battery use to reduce the amount of projected battery energy use during one or more cook phases to an amount less than the available battery energy to allow the entire cook mode to complete.

The available cook mode/phase time may be displayed (e.g., as a countdown) during cooking to communicate available battery energy. When a cook time is entered or estimated, the projected battery energy used by the cook mode/phase may be displayed to the user (e.g., “mode will use 45% of total battery energy,” “cooking for 25 min will use 30% of total battery energy,” etc.).

Now that the construction of cooking appliance 100 and heating system 200 have been presented according to exemplary embodiments, an exemplary method 300 of operating a heating system of a cooking appliance will be described. Although the discussion below refers to the exemplary method 300 with respect to cooking appliance 100, one skilled in the art will appreciate that the exemplary method 300 is applicable to any other suitable number, type, and configuration of cooking appliances. In exemplary embodiments, the various method steps as disclosed herein may be performed by a remote server 112, one or more controllers (e.g., such as controllers 166) or by a separate, dedicated controller that may be located locally on cooking appliance 100, remotely on a remote server, etc.

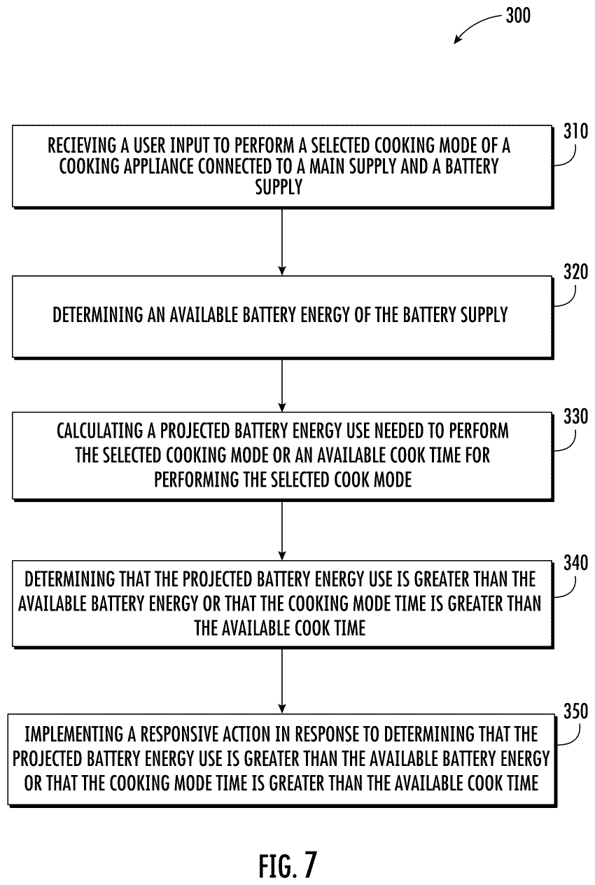

Referring specifically to FIG. 7, method 300 may include, at step 310, receiving a user input to perform a selected cooking mode. In this regard, a user may use control inputs 162, a remote device (e.g., a mobile phone), or any other suitable device for entering desired cooking parameters for one or more heating systems of a cooking appliance. For example, the user may select a Bake mode of operation at a target cooking temperature (e.g., 350° Fahrenheit), may select a target cooking duration, etc. Similarly, a selected cooking mode may include operation of one or more heating elements on the cooktop. In addition, the user may select a multi-phase cooking mode (for either the oven or the cooktop) where the cooking temperature and/or heater usage is adjusted at predetermined times/temperatures during the cooking mode.

Step 320 includes determining an available battery energy of the battery supply. In this regard, a controller of the cooking appliance may periodically or consistently monitor a state of charge of the battery supply (e.g., by monitoring battery voltage, historical battery voltage, and/or historical battery current draw) to determine the amount of energy that could be delivered by the battery supply before it would need to be recharged or would otherwise be depleted. According to example embodiments, determining the available battery energy of the battery supply may account for at least one of a battery age, a battery charge/discharge history, time required to charge, or a battery temperature. In general, the controller may be programmed to monitor the health and performance history of the battery supply to provide a more accurate estimate of the available battery energy.

Step 330 includes calculating a projected battery energy use needed to perform the selected cooking mode or an available cook time for performing the selected cook mode. In this regard, the controller may be programmed to take all available information regarding the selected cooking mode or an available cook time for performing the selected cooking mode to make an accurate estimate of how much battery energy would be needed to complete the mode. The controller determines a cook mode time, which may be provided by the user or estimated by the controller. The controller also determines the projected battery power use of the cook mode. For example, if a single-phase oven cook mode is selected, the controller may estimate the total amount of heating energy needed to maintain the oven at the desired temperature for the cook mode time. The controller may then estimate the portion of the total energy use that would be provided by the battery. The projected battery energy use of a cook mode may be calculated as a product of cook mode time and projected battery power use during the cook mode (e.g., average projected battery power multiplied by cook mode time, or the sum of projected battery power use over discrete time periods multiplied by those time periods). Alternatively, available cook time may be calculated as a product of available battery energy and projected battery power use during the cook mode. In addition, if one or more cooktop heaters are activated, calculating the projected battery energy needed to perform the selected cooking mode (or the available cook time for performing the selected cook mode) may account for operation of the one or more cooktop heaters.

In addition, the selected cooking mode may be a multi-phase cooking mode. According to such an embodiment, calculating the cook mode time and projected battery power use needed to perform the selected cooking mode may include calculating the cook phase time and projected battery power use needed for each phase of the multi-phase cooking mode. Similarly, calculating the projected battery energy use of the selected cooking mode may include calculating the projected battery energy use of each phase of the multi-phase cooking mode, and calculating the available cook time for the selected cooking mode may include calculating the available cook time for each phase of the multi-phase cooking mode.

In addition, the controller may take into account whether the cooking chamber is already at temperature or whether a preheat phase would be required. For example, the controller may determine a cook phase time for the preheat phase (e.g., estimating cook phase time based on energy require to preheat to a given temperature, paired with power use of the cook phase), determine a projected battery power use during the preheat phase, and calculate an available cook phase time (during the preheat phase) based on the available battery energy and the projected battery power use during the preheat phase. Therefore, the selected cook mode may include portions of oven operation when food is not present within the oven and/or on the cooktop.

Step 330 may constantly update the cook mode/phase time and projected battery power use as demands on the cooking appliance are changed, e.g., via cooking mode adjustments. In addition, the projected battery power use may be changed based on selected cooking settings, temperatures of the food/cookware placed in the oven or on the cooktop, usage history, etc. For example, determining the projected battery power use needed to perform the selected cooking mode comprises obtaining historical data related to battery power use.

Step 340 includes determining that the projected battery energy use is greater than the available battery energy. Alternatively, step 340 includes determining that the cook mode time is greater than the available cook time. According to an example embodiment, method 300 may further include determining that the projected battery energy use is less than or equal to the available battery energy (or determining that the cook mode time is less than the available cook time) and operating the power switching system to energize the one or more electric heaters and perform the selected cooking mode. In this regard, if based on the analysis described herein, the available battery energy is sufficient to complete the selected cooking mode, the controller may initiate and perform the cooking mode as requested by the user, e.g., without adjustments to lower battery power or energy use.

Step 350 includes implementing a responsive action in response to determining that the projected battery energy use is greater than the available battery energy (or determining that the cook mode time is greater than the available cook time). In this regard, if the available battery energy is not sufficient to perform the selected cooking mode, the controller may present the user with options for adjusting the cooking mode to complete the cooking process within the available battery energy. For example, implementing the responsive action may include reducing projected battery energy use (or increasing available cook time) by adjusting at least one of heater power source, heater timings, or heater power settings such that projected battery energy use is less than or equal to the available battery energy (or such that available cook time is greater than or equal to the cook mode time). In addition, implementing the responsive action may include providing a user notification that the projected battery energy use is greater than the available battery energy (or that cook mode time is greater than the available cook time) and requesting a user input regarding an alternative power schedule that reduces projected battery energy use (or increases available cook time). Examples of how this may be performed will be described in more detail below.

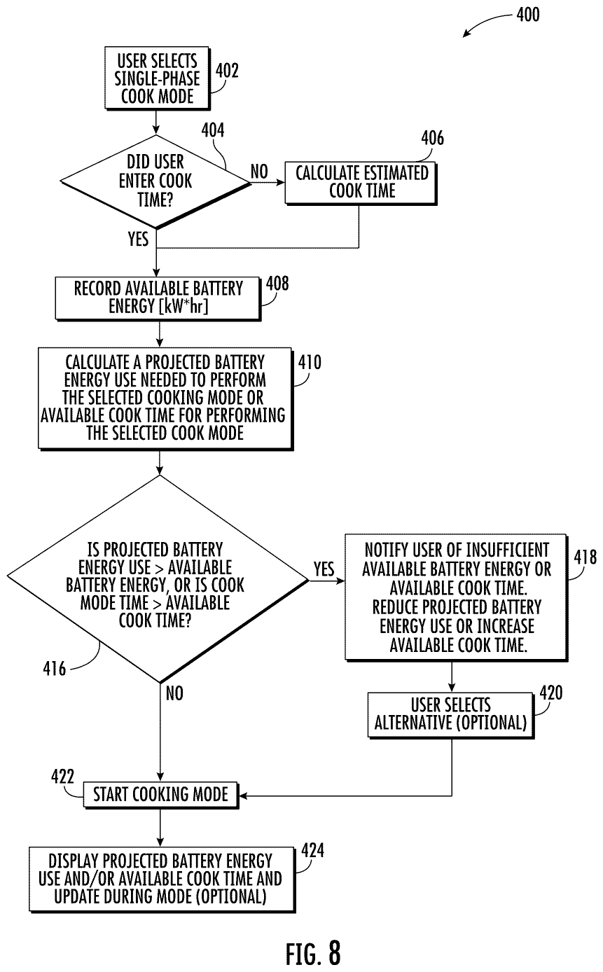

Referring now to FIG. 8, an example method 400 of implementing a single-phase cooking mode will be described. In this regard, step 402 may include receiving a user selection to perform a single-phase cooking mode (e.g., a cooking mode that does not include a preheat phase, or a mode started after the cooking chamber is already at or near a target temperature). For example, a user may select a Bake mode set to a target temperature of 350° F.

Step 404 may include determining whether the user entered a cook mode time or whether an open-ended cooking mode was requested. If no cook mode time was entered, step 406 may include determining or calculating an estimated cook mode time, e.g., based on historical cook mode time, cooking utensil or food type determinations, etc. Step 408 may include recording, determining, or calculating the available battery energy (e.g., in kW*hr) of the battery supply. Step 410 may include determining the projected battery power use of the selected cooking mode (e.g., in Watts or kW*hr/min). Step 410 also includes calculating the projected battery energy use needed to perform the selected cooking mode (e.g., based on the projected battery power use of the selected cooking mode and the cook mode time, in kW*hr). Step 410 may alternatively include determining an available cook time for performing the selected cooking mode, e.g., based on the available battery energy and the projected battery power use of the selected cooking mode.

Step 416 may include determining whether the projected battery energy use needed to perform the selected cooking mode (calculated at step 410) is greater than the available battery energy (recorded at step 408). Step 416 may alternatively include determining whether the cook mode time (entered by the user or estimated at step 406) is greater than the available cook time (calculated at step 410). If the projected battery energy use needed to perform the selected cooking mode is greater than the available battery energy, or if the cook mode time is greater than the available cook time, step 418 may include notifying the user of insufficient available battery energy or available cook time and reducing projected battery energy use to or below available battery energy (or increasing available cook time to or above cook mode time) by adjusting heater sources/timings/power settings. The manner of reducing battery usage may rely in part on user input, e.g., via additional user inputs, preferences, etc., which may be input at step 420. Step 422 may include starting the cooking mode according to the selected cooking mode if the projected battery energy use of the selected cooking mode is less than the available battery energy (or if the cook mode time is less than the available cook time), or according to the modified (reduced battery usage) parameters if the projected battery energy use of the selected cooking mode is greater than the available battery energy (or if the cook mode time is greater than the available cook time). Step 424 may include optionally displaying the projected battery energy use and/or the available cook time and updating periodically throughout the cooking mode.

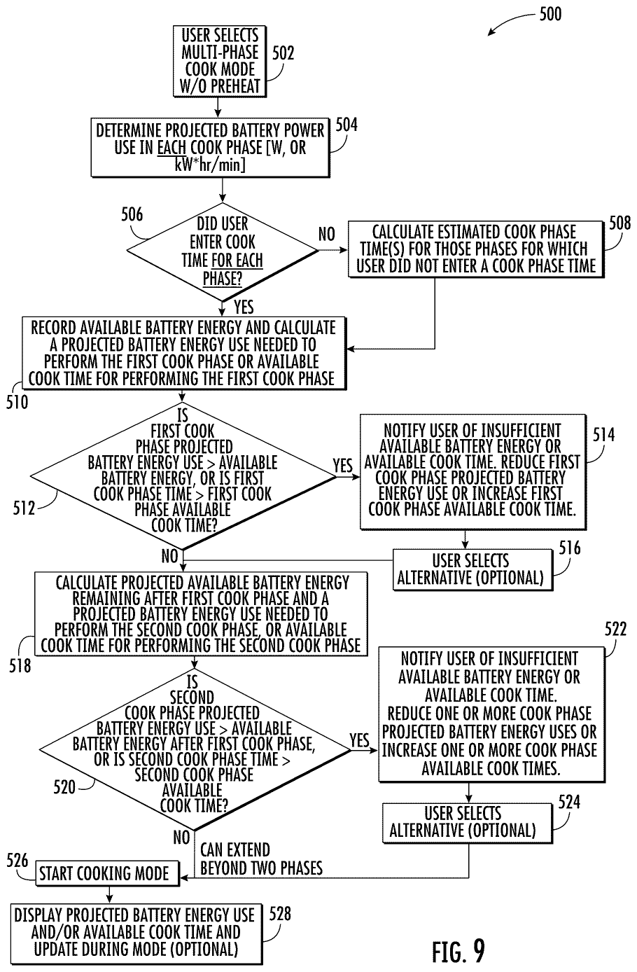

Referring now to FIG. 9, an example method 500 of implementing a multi-phase cooking mode without a preheat phase will be described. Certain steps of method 500 may be similar to steps performed in method 400, and these steps may be omitted here for brevity. In this regard, step 502 may include receiving a user selection to perform a multi-phase cooking mode that does not include a preheat phase, or which is started after the cooking chamber is already at or near a target temperature (e.g., Bake at 350° F. for a first phase, followed by Bake at 400° F. for a second phase). Step 502 may also include receiving an optional user selection of one or more cook phase times (e.g., 30 minutes for a first phase, followed by 20 minutes for a second phase). Step 504 may include determining projected battery power use in each phase of the selected cooking mode (e.g., in Watts or kW*hr/min). Step 506 may include determining whether the user entered a cook time for each phase and step 508 may include estimating a cooking phase time for any phases for which the user did not specify a cooking time.

Step 510 may include recording, determining, or calculating the available battery energy (e.g., in kW*hr) of the battery supply. Step 510 may also include calculating the projected battery energy use needed to perform the first cook phase of the selected cooking mode (e.g., based on the projected battery power use of the first phase of the selected cooking mode and the first cook phase time, in kW*hr). Step 510 may alternatively include determining an available cook time for performing the first phase of the selected cooking mode, e.g., based on the available battery energy and the projected battery power use of the first phase of the selected cooking mode. Step 512 may include determining whether the projected battery energy use needed to perform the first phase of the selected cooking mode is greater than the available battery energy. Step 512 may alternatively include determining whether the first cook phase time (for the first phase of a multi-phase mode) is greater than the available cook time for performing the first cooking phase. If the projected battery energy use needed to perform the first phase of the selected cooking mode is greater than the available battery energy, or if the first cook phase time exceeds the available cooking time for the first cook phase, step 514 may include notifying the user of insufficient available battery energy or available cook time and reducing projected battery energy use of the first cook phase to or below available battery energy (or increasing available cook time of the first cook phase to or above the first cook phase time) by adjusting heater timings/power sources, etc. The manner of reducing battery usage may rely in part on user input, e.g., via additional user inputs, preferences, etc., which may be input at step 516.

Step 518 may include calculating projected available battery energy remaining after the first cook phase. Step 518 may also include calculating the projected battery energy use needed to perform the second cook phase of the selected cooking mode (e.g., based on the projected battery power use of the second phase of the selected cooking mode and the second cook phase time, in kW*hr). Step 518 may alternatively include determining an available cook time for performing the second phase of the selected cooking mode, e.g., based on the projected available battery energy remaining after the first cook phase and the projected battery power use of the second phase of the selected cooking mode. Step 520 may include determining whether the projected battery energy use needed to perform the second phase of the selected cooking mode is greater than the projected available battery energy remaining after the first cook phase. Step 520 may alternatively include determining whether the second cook phase time (for the second phase of a multi-phase mode) is greater than the available cook time for performing the second cooking phase. If projected battery energy use needed to perform the second phase of the selected cooking mode is greater than the projected available battery energy remaining after the first cook phase, or if the second cook phase time exceeds the available cooking time for the second cook phase, step 522 may include notifying the user of insufficient available battery energy or available cook time and reducing projected battery energy use of one or more cook phases such that that total cook mode projected battery energy use is at or below available battery energy (or increasing available cook time of one or more cook phases such that total cook mode available cook time is at or above total cook mode time) by adjusting heater timings/power sources, etc. The manner of reducing battery usage may rely in part on user input, e.g., via additional user inputs, preferences, etc., which may be input at step 524. This process may be repeated as needed for additional stages.

Step 526 may include starting the cooking cycle according to the selected cooking mode if the total projected battery energy use of all of the selected cooking mode phases are less than the available battery energy (or if the total cook mode time is less than the available cook time for all cook phases), or according to the modified, reduced battery usage parameters if the projected battery energy use of at least one of the selected cooking mode phases is greater than the available battery energy for that phase (or if the cook phase time of at least one phase is greater than the available cook time for that cook phase). Step 528 may include optionally displaying the projected battery energy use and/or the available cook time and updating periodically throughout the cooking cycle.

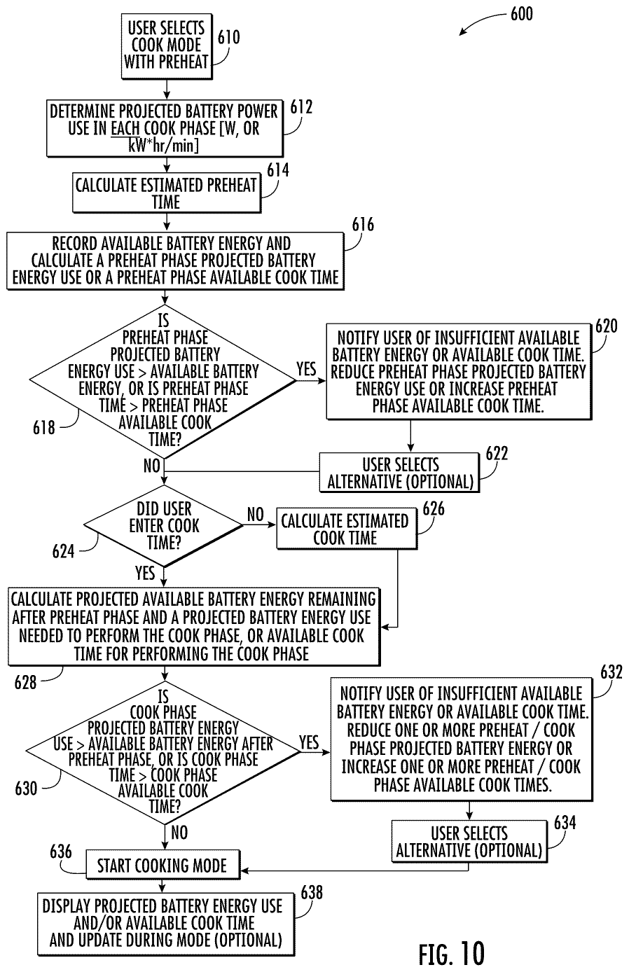

Referring now to FIG. 10, an example method 600 of implementing a multi-phase cooking mode with preheat will be described. Certain steps of method 600 may be similar to steps performed in methods 400 or 500, and these steps may be omitted here for brevity. In this regard, step 610 may include receiving a user selection to perform a multi-phase cooking mode that includes a preheat phase (e.g. Bake at 350° F. when the cooking chamber is not at or near the target temperature). Step 612 may include determining a projected battery power use in each phase of the selected cooking mode, including the preheat phase (e.g., in Watts or kW*hr/min). Step 614 may include calculating an estimated preheat time, e.g., based on the current and target chamber temperatures. Step 616 may include recording available battery energy and calculating a preheat phase projected battery energy use or a preheat phase available cook time. Step 618 may include determining whether the preheat phase projected battery energy use is greater than the available battery energy or whether the preheat phase time is greater than the preheat phase available cook time. If the preheat phase projected battery energy use is greater than the available battery energy or the preheat phase time is greater than the preheat phase available cook time, step 620 may include notifying the user, reducing battery usage, adjusting heater timings/power sources, etc. The manner of reducing battery usage may rely in part on user input, e.g., via additional user inputs, preferences, etc., which may be input at step 622.

Step 624 may include determining whether the user entered a cook time for the cook phase (after the preheat phase), or whether an open-ended cooking cycle was requested. If no cook time was entered, step 626 may include calculating an estimated cook time, e.g., based on historical cycle time, cooking utensil or food type determinations, etc. Step 628 may include calculating projected available battery energy remaining after the preheat phase. Step 628 may also include calculating the projected battery energy use needed to perform the cook phase of the selected cooking mode, or may alternatively include calculating an available cook time for the cook phase (e.g., remaining after preheat), i.e., an available cook time based on the remaining battery energy. Step 630 may include determining whether the projected battery energy use needed to perform the cook phase of the selected cooking mode is greater than the projected available battery energy remaining after the preheat phase. Step 630 may alternatively include determining whether the cook phase time is greater than the available cook phase time for performing the cook phase after the preheat phase (e.g., calculated at step 628).

If the projected battery energy use needed to perform the cook phase of the selected cooking mode is greater than the projected available battery energy remaining after the preheat phase, or if the cook phase time exceeds the available cooking time for the cook phase, step 632 may include notifying the user, reducing battery usage, adjusting heater timings/power sources, etc. The manner of reducing battery usage may rely in part on user input, e.g., via additional user inputs, preferences, etc., which may be input at step 634. This process may be repeated as needed for additional stages. Step 636 may include starting the cooking cycle according to the selected cooking mode if the total projected battery energy use of all of the selected cooking mode phases (e.g. preheat and cook phases) are less than the available battery energy (or if the total cook mode time, including both preheat and cook phase times, is less than the available cook time), or according to the modified, reduced battery usage parameters if the projected battery energy use of at least one of the selected cooking mode phases is greater than the available battery energy for that phase (or if the cook phase time of at least one phase exceeds the available cook time for that phase). Step 638 may include displaying the projected battery energy use and/or available cook time and updating periodically throughout the cooking cycle.

FIGS. 7 through 10 depict exemplary control methods having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of this method are explained using cooking appliance 100 and heating system 200 as an example, it should be appreciated that this method may be applied to operating any suitable heating system or cooking appliance.

To facilitate improved understanding of the control methods described herein, examples will be provided. Specifically, the examples below refer to oven operation only in a cooking appliance. It should be appreciated that these examples are provided only for the purposes of improved understanding using example values, and the presently disclosed methods are not limited to such values, steps, etc.

For example, to illustrate calculation of projected average battery power use in a multi-phase cook mode that includes a preheat phase, a bake mode set to 350° Fahrenheit in an oven appliance may be selected. In the mode's first (preheat) phase, the bake heater is driven 61% of the time from the battery (at 2,821 Watts) and 39% of the time from the main supply (at 768 Watts), and in which the broil heater is driven 100% of the time from the main supply (at 929 Watts). In the mode's second (cooking) phase, during a call for heat, the bake heater is driven 8% of the time from the battery (at 2,821 Watts) and 92% of the time from the main supply (at 768 Watts), and the broil heater is driven 30% of the time from the main supply (at 929 Watts), and is not powered for 70% of the call-for-heat time. The controller is programmed using empirical data, estimating that the call-for-heat ratio during bake at 350 °F is 60%. During the preheat phase, the projected average total power use may be 2,821 W*0.61+768 W*0.39+929 W*(1.00)=2,950 W and the projected average battery power use may be 2,821 W*0.39=1,721 W. During the cooking phase, the projected average total power use may be (2,821 W*0.08+768 W*0.92+929 W*(0.30))*0.60=727 W and the projected average battery power use may be 2,821 W*0.08*0.60=135 W.

According to another example embodiment, to illustrate modification of preheat phase parameters and use of a margin factor applied to preheat phase available cook time, a multi-phase cook mode that includes a preheat phase may be selected (e.g. Bake 400° F.). Preheat phase heater settings (from the previous example) yield 2,950 W projected average total power use and 1,721 W of projected average battery power use, the preheat phase is estimated to take 14.1 min, and the preheat phase is projected to consume 0.40 kW*hr of battery energy. Available battery energy of 0.34 kW*hr is sufficient only for 11.9 min (preheat phase available cook time) of the standard preheat phase of this cooking mode. A 20% margin factor applied to the 11.9 min preheat phase available cook time reduces it to 9.5 min. Estimated preheat phase time is greater than preheat phase available cook time (with margin), so battery power may be reduced.

In this situation, the cooking appliance may adjust preheat phase battery use by changing the proportion of time the bake heater is powered by the battery from 61% to 26%, adjusting the proportion of time the bake heater is powered by the main supply from 39% to 74%, and adjusting the proportion of time the broil heater is powered by the main supply from 100% to 64%. This reduces projected average total power use during preheat from 2,950 W to 1,896 W, projected average battery power use during preheat from 1,721 W to 734 W, extends estimated preheat time from 14.1 to 21.9 min, and reduces projected battery energy use from 0.40 to 0.27 kW*hr. Using these settings, available battery energy is sufficient for 27.8 min of operation. A 20% margin factor applied to the 27.8 min preheat phase available cook time reduces it to 22.2 min, which is greater than estimated preheat time of 21.9 min. After the preheat phase is complete, the oven may use only the main supply power during the second cook phase, yielding an infinite second phase available cook time.

According to another example embodiment, to illustrate user-entered cook time in a multi-phase cook mode that includes a preheat phase and use of a margin factor applied to cook time, a multi-phase cook mode (e.g. Bake 475° F. with preheat) and a second phase cook time (e.g. 15 min) may be selected. Preheat phase heater settings (from the first example) yield 2,950 W projected average total power use and 1,721 W of projected average battery power use, the preheat phase is estimated to take 17.4 min, and the preheat phase is projected to consume 0.50 kW*hr of battery energy. Available battery energy of 0.65 kW*hr is sufficient for 22.7 min (preheat phase available cook time) of the standard preheat phase of this cooking mode. A 25% margin factor applied to the 17.4 min estimated preheat phase time increases it to 21.7 min. The estimated preheat phase time (with margin) is less than the preheat phase available cook time, so no adjustments are made yet.

The second (cooking) phase settings (from the first example) yield 226 W of projected average battery power use. Projected available battery energy remaining after the estimated preheat phase time (with margin) of 21.7 min is 0.03 kW*hr and is sufficient for 7.3 min (second phase available cook time) of the standard second (cooking) phase of this cooking mode. A 25% margin factor applied to the 15 min user-entered second cook phase time increases it to 18.8 min. The second cook phase time (with margin) is greater than the second phase available cook phase time, so adjustments are proposed to increase the total cook mode available cook time.

In this situation, the cooking appliance may adjust preheat phase battery use by changing the proportion of time the bake heater is powered by the battery from 61% to 49%, adjusting the proportion of time the bake heater is powered by the main supply from 39% to 51%, and adjusting the proportion of time the broil heater is powered by the main supply from 100% to 86%. This reduces projected average total power use during preheat from 2,950 W to 2,572 W, projected average battery power use during preheat from 1,721 W to 1,382 W, extends estimated preheat time from 17.4 to 19.9 min, and reduces preheat phase projected battery energy use to 0.46 kW*hr. A 25% margin factor applied to the 19.9 min estimated preheat phase time increases it to 24.9 min. Using these settings, projected available battery energy remaining after the preheat phase time (with margin) is 0.08 kW/hr. This remaining available battery energy is sufficient for 20.4 min of operation (second phase available cook time), which is greater than the second cook phase time (with margin) of 18.8 min.

To facilitate improved understanding of the control methods described herein, examples will be provided. Specifically, the examples below refer to cooktop operation only in a cooking appliance. It should be appreciated that these examples are provided only for the purposes of improved understanding using example values, and the presently disclosed methods are not limited to such values, steps, etc.

For example, to illustrate calculation of projected average battery power, if a user sets the right-front (RF) heater (rated 3,700 W max) to 100% power and the left-front (LF) heater (rated 2,500 W max) to 50% power, the RF heater may be powered by the battery and the LF heater may be powered by the main supply. In this scenario, the projected average total power use may be calculated as 3,700 W*1.00+2,500 W*0.50=4,950 W. The projected average battery power use may be calculated as 3,700 W*1.00=3,700 W.

According to another example embodiment, to illustrate user-entered cook times for each heater and calculation using both projected battery energy use and available cook time, the user may set the cooktop heater powers and also provide a cook mode time for each heater. For example, the user may set the RF heater to 100% power (3,700 W) for 25 min and the LF heater to 50% power (1,250 W) for 40 min, where both heaters are powered by the battery. Available battery energy is 2.10 kW*hr. As the heaters are powered for different times, this is treated as a multi-phase cook mode where during the first phase, both heaters are powered, and during the second phase, only the LF heater is powered. During the first phase (25 min of operation), projected battery power use is 4,950 W and projected battery energy use is 2.06 kW*hr. Available battery energy of 2.10 kW*hr is sufficient for this first phase, after which 0.04 kW*hr of battery energy is projected to remain. Alternatively, first cook phase available cook time is calculated to be 25.5 min, which is sufficient for the first cook phase time of 25 min. During the second phase (15 min of operation) when only the LF heater is powered, projected battery power use is 1,250 W and projected battery energy use is 0.31 kW*hr, which is greater than available battery energy remaining after the first phase (0.04 kW*hr). Alternatively, second cook phase available cook time is calculated to be 1.8 min, which is less than the second cook phase time of 15 min. For either of these reasons, adjustments may be proposed to either reduce total cook mode projected batter energy use or increase total cook mode available cook time. For example, adjusting the RF heater to 82% power (during the first cook phase) would reduce first phase projected battery energy use from 2.06 kW*hr to 1.79 kW*hr. This would leave 0.31 kW*hr of battery energy remaining for the second cook phase, which would be sufficient for the projected second phase battery energy use of 0.31 kW*hr. As an alternative calculation, the projected available battery energy remaining after the first phase would yield a second phase available cook time of 15.1 min, which is sufficient for the second phase cook time of 15 min.

According to another example embodiment, to illustrate a multi-phase cook mode using a single heater and modified cook mode heater settings that use either battery and main supply power, the user may set the cooktop heater powers and cook times for a two-phase cooktop mode using the RF heater. For example, the user may set the RF heater to 80% power (2,960 W) for 10 min, followed by 50% power (1,850 W) for 15 min, where both heaters are powered by the battery. Available battery energy is 0.85 kW*hr, and the main supply can provide up to 1,700 W. During the first phase (10 min of operation), projected battery power use is 2,960 W and projected battery energy use is 0.49 kW*hr. Available battery energy of 0.85 kW*hr is sufficient for this first phase, after which 0.36 kW*hr is projected to remain. Alternatively, first cook phase available cook time is calculated to be 17.2 min, which is sufficient for the first cook phase time of 10 min. First phase projected battery energy use is less than available battery energy (or alternatively, first phase available cook time is greater than first cook phase time), so no adjustments are made yet.

During the second phase (15 min of operation), projected battery power use is 1,850 W and projected battery energy use is 0.46 kW*hr, which is greater than available battery energy remaining after the first phase (0.36 kW*hr). Alternatively, second cook phase available cook time is calculated to be 11.6 min, which is less than the second cook phase time of 15 min. For either of these reasons, adjustments may be proposed to either reduce total cook mode projected battery energy use or increase total cook mode available cook time. For example, the cooking appliance may adjust the RF heater's phase 1 power level from 80% (2,960 W) to 62% (2,294 W), reducing phase 1's projected battery energy use from 0.49 kW*hr to 0.38 kW*hr. This would leave 0.47 kW*hr of battery energy remaining for the second cook phase, which would be sufficient for the projected second phase battery energy use of 0.38 kW*hr. As an alternative calculation, the projected available battery energy remaining after the first phase would yield a second phase available cook time of 15.2 min, which is sufficient for the second phase cook time of 15 min. Alternatively, instead of reducing the phase 1 power level, the product may adjust the phase 2 power level from 50% (1,850 W) to 45% (1,665 W). This would enable the RF heater to be powered from the main supply (which can provide up to 1,700 W) and would require no battery energy use in phase 2.

To facilitate improved understanding of the control methods described herein, examples will be provided. Specifically, the examples below refer to operation of both the oven and the cooktop in a cooking appliance. It should be appreciated that these examples are provided only for the purposes of improved understanding using example values, and the presently disclosed methods are not limited to such values, steps, etc.

According to an example embodiment, the user may select a multi-phase oven mode with preheat and a user-set cook time, along with a single-phase cooktop mode with no time set. In this regard, the user may select a bake mode at 425° F. with a cook time of 20 min. Preheat is estimated to take 15.2 min (2,950 W average total power, 1,721 W of average battery power, consuming 0.44 kW*hr). The user may also set the RF heater to 100% power (3,700 W) and not set a cook time.

The battery charge of 2.00 kW*hr is sufficient for 22.1 min (cooktop and oven preheat phase available cook time) of the standard preheat phase of this cooking mode plus cooktop operation. A 25% margin factor applied to the 15.2 min oven preheat phase time increases it to 19.0 min. The estimated oven preheat phase time (with margin) is less than the cooktop and oven preheat phase available cook time, so no adjustments are made yet.

The oven cooking phase uses 226 W of average battery power. Predicted battery charge remaining after oven preheat (0.28 kW*hr, assuming its length equals the oven preheat phase time [with margin] of 19.0 min) is sufficient for 4.3 min (cooktop and oven cook phase available cook time) of the standard cooking phase of this cooking mode plus cooktop operation. A 25% margin factor applied to the 20 min oven cook phase time increases it to 25 min. This is greater than the cooktop and oven cook phase available cook time, so adjustments may be proposed to increase the cooktop and oven cook phase available cook time.

Cooktop heater power may be adjusted to increase total cooktop and oven cook mode available cook time. In this regard, the cooking appliance may adjust the RF heater from 100% power (3,700 W) to 50% (1,850 W). This increases predicted battery charge remaining after oven preheat from 0.28 kW*hr to 0.87 kW/hr, assuming its length equals the oven preheat phase time (with margin) of 19.0 min. This charge is sufficient for 25.1 min of operation (cooktop and oven cook phase available cook time), which is greater than the oven cook phase time (with margin) of 25.0 min.

According to still another example embodiment, the user may select a multi-phase oven mode with preheat and a user-set cook time, along with a single-phase cooktop mode with a user-set cook time. For example, the user may select a bake mode at 425° F. with a cook time of 20 min. Preheat is estimated to take 15.2 min (2,950 W average total power, 1,721 W of average battery power, consuming 0.44 kW*hr). The user may also set the RF heater to 100% power (3,700 W) with a cook time of 15 min.

Since cooktop cook time expires before the estimated oven preheat time, the battery charge used by the cooktop during its cook time may be predicted (1.16 kW*hr, or 3,700 W for set cooktop cook time of 15 min+25% margin) and subtracted from the total available battery charge of 1.75 kW*hr before calculating oven available preheat phase time. The remaining battery charge of 0.59 kW*hr is sufficient for 20.7 min (oven preheat phase available cook time) of the standard preheat phase of this cooking mode plus cooktop operation. A 25% margin factor applied to the 15.2 min oven preheat phase time increases it to 19.0 min. The estimated oven preheat phase time (with margin) is less than the oven preheat phase available cook time, so no adjustments are made yet.

The oven cooking phase uses 226 W of average battery power. The predicted battery charge remaining after oven preheat (0.05 kW*hr, assuming its length equals the oven preheat phase time [with margin] of 19.0 min) is sufficient for 13.0 min (oven cook phase available oven cook time) of the standard cooking phase of this cooking mode. A 25% margin factor applied to the 20 min oven cook phase time increases it to 25 min. This is greater than the oven cook phase available oven cook time, so adjustments may be proposed to increase the oven cook phase available oven cook time.

For example, the cooking appliance may adjust the RF heater from 100% power (3,700 W) to 96% (3,552 W). This increases the battery charge remaining after oven preheat from 0.05 kW*hr to 0.10 kW/hr, assuming its length equals the oven preheat time (with margin) of 19.0 min. This charge is sufficient for 25.3 min of operation (available oven cooking phase duration), which is greater than oven cook phase cook time (with margin) of 25.0 min. Alternatively, the product may adjust preheat battery use from 61% to 48% (powering the 2,821 W bake heater). This reduces oven power during preheat (2,553 W average total power, 1,354 W average battery power), extends estimated preheat time from 15.2 to 17.6 min, and reduces preheat battery energy use from 0.44 kW*hr to 0.40 kW*hr. The battery charge remaining after oven preheat is 0.10 kW/hr, assuming its length equals the recalculated oven preheat time (with margin) of 21.9 min (17.6 min estimated duration +25% margin). This charge is sufficient for 26.2 min of operation (oven cook phase available cook time), which is greater than oven cook phase time (with margin) of 25.0 min.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a cabinet defining a cooking chamber;
one or more electric heaters in thermal communication with the cooking chamber;
a main power connection to a main supply of electrical power at a first voltage;
an auxiliary power connection to a battery supply of electrical power at a second voltage;
a power switching system configured to selectively couple at least one of the main power connection or the auxiliary power connection to the one or more electric heaters; and
a controller in operative communication with the power switching system, the controller being configured to:
receive a user input to perform a selected cooking mode;
determine an available battery energy of the battery supply;
calculate a projected battery energy use needed to perform the selected cooking mode or an available cook time for performing the selected cooking mode;
determine that the projected battery energy use is greater than the available battery energy or that the cooking mode time is greater than the available cook time; and
implement a responsive action in response to determining that the projected battery energy use is greater than the available battery energy or that the cooking mode time is greater than the available cook time.

2. The cooking appliance of claim 1, wherein calculating the available cook time comprises:
calculating a rate of battery energy usage based on the selected cooking mode;
and calculating an available cook time based on the rate of battery energy usage and the available battery energy.

3. The cooking appliance of claim 1, wherein calculating the projected battery energy use comprises:
determining a rate of battery energy usage of the selected cooking mode; and
recording or estimating a cook mode time of the selected cooking mode.

4. The cooking appliance of claim 1, wherein implementing the responsive action comprises:
reducing battery usage to either reduce the projected battery energy use below the available battery energy or increase the available cook time above the cook mode time, by adjusting at least one of heater power sources, heater duty cycles, or heater power settings.

5. The cooking appliance of claim 1, wherein implementing the responsive action comprises:
providing a user notification that the projected battery energy use is greater than the available battery energy or that the cooking mode time is greater than the available cook time; and
requesting a user input regarding an alternative power schedule that reduces battery usage.

6. The cooking appliance of claim 1, wherein the selected cooking mode is a multi-phase cooking mode, and wherein calculating the projected battery energy use needed to perform the selected cooking mode or the available cook time for performing the selected cooking mode comprises calculating projected battery energy use needed for each phase of the multi-phase cooking mode.

7. The cooking appliance of claim 6, wherein determining that the projected battery energy use is greater than the available battery energy or that the cooking mode time is greater than the available cook time comprises calculating a projected battery energy use needed to perform each phase of the multi-phase cooking mode and comparing the projected battery energy use for each phase to a remaining available battery energy after performance of any prior phases of the multi-phase cooking mode.

8. The cooking appliance of claim 1, wherein the selected cooking mode comprises a preheat phase and the controller is further configured to:
calculate an estimated preheat phase time;
determine a rate of battery energy usage based on the preheat phase; and
calculate a preheat phase projected battery energy use or a preheat phase available cook time based on the rate of battery energy usage and the available battery energy.

9. The cooking appliance of claim 1, wherein the cooking appliance further comprises:
one or more cooktop heaters, wherein the selected cooking mode comprises operation of the one or more cooktop heaters, and wherein calculating the projected battery energy use needed to perform the selected cooking mode or the available cook time for performing the selected cooking mode accounts for operation of the one or more cooktop heaters.

10. The cooking appliance of claim 1, wherein the controller is further configured to:
determine that the projected battery energy use is less than or equal to the available battery energy or that the cooking mode time is less than or equal to the available cook time; and
operate the power switching system to energize the one or more electric heaters and perform the selected cooking mode without adjusting heater power sources, heater duty cycles, or heater power settings of the selected cooking mode.

11. The cooking appliance of claim 1, wherein calculating the projected battery energy use needed to perform the selected cooking mode or the available cook time for performing the selected cooking mode comprises obtaining historical data related to battery energy usage.

12. The cooking appliance of claim 1, wherein determining the available battery energy of the battery supply accounts for at least one of a battery age, a battery charge/discharge history, or a battery temperature.

13. The cooking appliance of claim 1, wherein determining the available battery energy of the battery supply or the available cook time for performing the selected cooking mode comprises:
estimating an amount of battery charging expected to occur during the selected cooking mode; and
adjusting the available battery energy or the available cook time based on the amount of battery charging expected to occur.

14. The cooking appliance of claim 1, wherein calculating the projected battery energy use or the cooking mode time needed to perform the selected cooking mode comprises:
estimating the projected battery energy use or the cooking mode time using programmed values or transfer functions, cook mode settings, temperature of cookware and/or food, identification of cookware and/or food, or historical usage.

15. A method of operating a cooking appliance, the cooking appliance comprising one or more electric heaters, a main power connection to a main supply of electrical power at a first voltage, an auxiliary power connection to a battery supply of electrical power at a second voltage, and a power switching system configured to selectively couple at least one of the main power connection or the auxiliary power connection to the one or more electric heaters, the method comprising:
receiving a user input to perform a selected cooking mode;
determining an available battery energy of the battery supply;
calculating a projected battery energy use needed to perform the selected cooking mode or an available cook time for performing the selected cooking mode;
determining that the projected battery energy use is greater than the available battery energy or that the cooking mode time is greater than the available cook time;
and implementing a responsive action in response to determining that the projected battery energy use is greater than the available battery energy or that the cooking mode time is greater than the available cook time.

16. The method of claim 15, wherein calculating the available cook time comprises:
calculating a rate of battery energy usage based on the selected cooking mode;
and calculating an available cook time based on the rate of battery energy usage and the available battery energy.

17. The method of claim 15, wherein implementing the responsive action comprises:
reducing battery usage by adjusting at least one of heater power sources, heater duty cycles, or heater power settings.

18. The method of claim 15, wherein implementing the responsive action comprises:
providing a user notification that the projected battery energy use is greater than the available battery energy or that the cooking mode time is greater than the available cook time; and
requesting a user input regarding an alternative power schedule that reduces battery usage.

19. The method of claim 15, wherein the selected cooking mode is a multi-phase cooking mode, and wherein calculating the projected battery energy use needed to perform the selected cooking mode or the available cook time for performing the selected cooking mode comprises calculating projected battery energy use needed for each phase of the multi-phase cooking mode.

20. The method of claim 15, wherein the cooking appliance further comprises:
one or more cooktop heaters, wherein the selected cooking mode comprises operation of the one or more cooktop heaters, and wherein calculating the projected battery energy use needed to perform the selected cooking mode or the available cook time for performing the selected cooking mode accounts for operation of the one or more cooktop heaters.
